(19) United States
(12) Patent Application Publication
(10) Pub. No.: US 2014/0320481 A1
(43) Pub. Date: Oct. 30, 2014

(54) DISPLAY CONTROL

(71) Applicant: HEWLETT-PACKARD DEVELOPMENT COMPANY, L.P., Houston, TX (US)

(72) Inventor: Andres Jose Odio Vivi, Heredia (CR)

(73) Assignee: Hewlett-Packard Development Company, L.P., Houston, TX (US)

(21) Appl. No.: 13/874,456

(22) Filed: Apr. 30, 2013

(51) Int. Cl. G09G 5/00

(52) U.S. Cl. CPC G09G 5/003
USPC 345/214

(57) ABSTRACT

An example method for controlling a display timer of a device in accordance with aspects of the present disclosure includes obtaining a motion reading of a motion event associated with the device from a motion sensor, comparing the motion reading to a threshold value, and performing an action on the display timer associated with a display unit of the device based on the comparison. The action maintains the display unit in a normal display mode.

### BACKGROUND

Electronic devices may include one or more sensors for detecting characteristics of the device and its surroundings. For example, an electronic device such as a mobile device may include one or more motion sensors. These sensors may be used to detect a motion of the device. The electronic device may process the data generated by the sensors and may be operative to perform particular operations based on the processed sensor data. For example, an electronic device may process motion sensor data to determine the number of steps taken by a user carrying the device, thereby providing a pedometer application.

To reduce power consumption of an electronic device, the device may turn off its screen after a period of inactivity. More specifically, a display screen of the electronic device may be put into a power saving mode when the display screen is not in use, and revert to a normal display when the display screen is to be used. The user of the electronic device may set a time interval (e.g., 30 seconds) for the application of the power saving mode according to a user's demands.

### BRIEF DESCRIPTION OF THE DRAWINGS

Example implementations are described in the following detailed description and in reference to the drawings, in which:

FIG. 1 illustrates example components of an example system in accordance with an implementation;

FIG. 2 illustrates example components of an example system in accordance with an implementation; and

FIG. 3 illustrates an example process flow diagram in accordance with an implementation.

### DETAILED DESCRIPTION

Various implementations described herein are directed to an electronic device that incorporates a motion sensor. More specifically, and as described in greater detail below, various aspects of the present disclosure are directed to a manner by which a sensor in an electronic device detects a motion of a device and accordingly controls the screen timer of the device.

Aspects of the present disclosure described herein obtain measurements of motions of the device and accordingly reset the timer of the screen of the device. According to various aspects of the present disclosure, the approach described herein allows a user to view information displayed on the screen without having to touch the screen or move a mouse or an input key of the portable electronic device to make the display screen stay in the normal display mode. Moreover, aspects of the present disclosure described herein also allow the user to automatically control a screen function of the electronic device by moving the device. Among other things, this approach allows the user to control the screen timer independent of a preset time interval. Accordingly, this approach may prevent the user from having to change a timer setting every time the user desires a different lapse time. Such aspects, among other things, increase the simplicity of the operation the electronic device and lead to an enjoyable experience.

In one example in accordance with the present disclosure, a method for controlling a display timer of a device is provided. The method comprises obtaining a motion reading of a motion event associated with the device from a motion sensor, comparing the motion reading to a threshold value, and performing an action on the display timer associated with a display unit of the device based on the comparison. The action maintains the display unit in a normal display mode.

In a further example in accordance with the present disclosure, a system is provided. The system comprises a motion sensor unit to detect a motion of a device and a processing unit communicatively coupled to the motion sensor unit to obtain a motion reading of a motion event associated with the device from a motion sensor, compare the motion reading to a threshold value, and perform an action on a display timer on the device based on the comparison, the action maintaining the device in a normal display mode.

In another example in accordance with the present disclosure, a non-transitory computer-readable medium is provided. The non-transitory computer-readable medium comprises instructions that when executed cause a device to (i) obtain a motion reading of a motion event associated with a device from a motion sensor, (ii) compare the motion reading to a threshold value, and (iii) perform an action on a display timer associated with a display unit of the device based on the comparison.

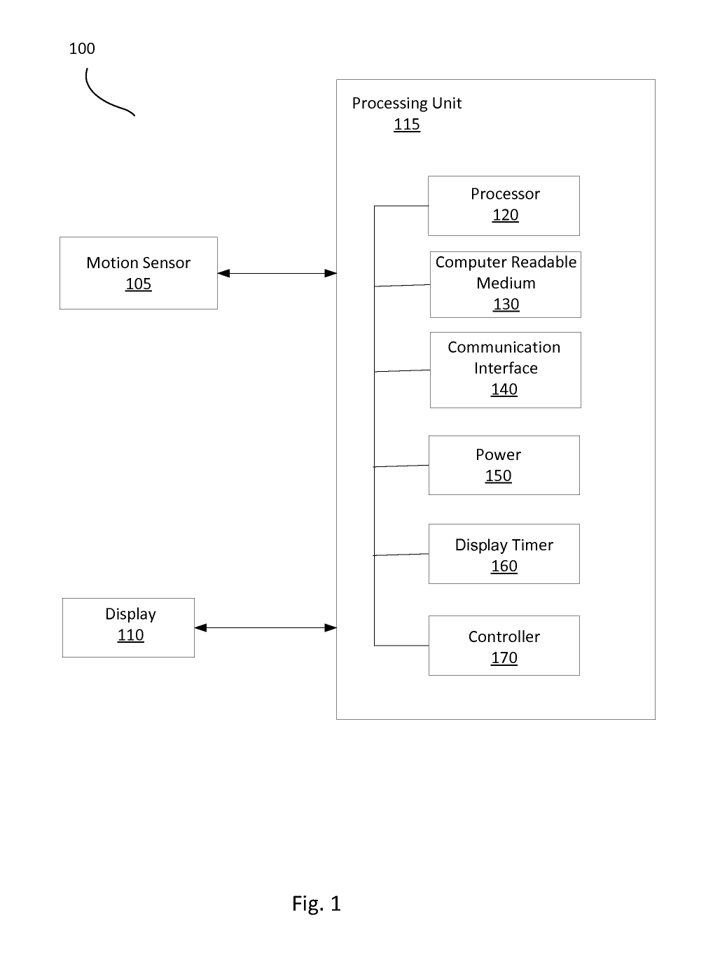

FIG. 1 illustrates example components of the system 100 in accordance with an implementation. It should be readily apparent that the system 100 illustrated in FIG. 1 represents a generalized depiction and that other components may be added or existing components may be removed, modified, or rearranged without departing from a scope of the present disclosure. The system 100 comprises a motion sensor 105, a display 110 and a processor unit 115 with a processor 120, a computer readable medium 130, a communications interface 140, a power 150, a display timer 160, a controller 170, each of which is described in greater detail below. The computer readable medium 130 may comprise various databases containing, for example, user profile data, user activity data and keyboard data. Moreover, the device system 100 may have a switch and other components that may be added, removed, modified, or rearranged without departing from a scope of the present disclosure. It should be readily apparent that while the system 100 illustrated in FIG. 1 includes only one motion sensor device 105, the system may actually comprise a plurality of sensor devices, and only one has been shown and described for simplicity.

The system 100 illustrates the electronic device that may be any portable, mobile, or hand-held electronic device, such as a laptop, a notebook, a tablet device, a personal digital assistant (PDA), or a mobile phone. The motion sensor 105 comprises, for example, a motion sensor or an accelerometer, for sensing a change of the motion status of the device and generating a sensing signal accordingly. Alternatively, it may also consist of a gyroscope, for sensing a change in the orientation of the device and generating a sensing signal accordingly. In one implementation, the system may be notified when the motion sensor 105 detects a motion. The processing unit 115 is coupled to the motion sensor 105 and the display 110, for processing a sensing signal sent by the motion sensor 105 and outputting a display signal to the display 110. Alternatively or in addition, the system 100 may include a bus that may provide a data transfer path for transferring data, to, from, or between various other components of device.

In some implementations, a user may interact with the device by controlling a keyboard, which may be an input device for the device. The device may help translate input received by the keyboard. The user may perform various gestures on the keyboard. Such gestures may involve, but not limited to, touching, pressing, waiving, placing an object in proximity.

The motion sensor 105 may be capable of detecting the movement of the device. The motion sensor 105 may use a variety of techniques for detecting the motion of the device. The motion sensor 105 may measure movement and rotation of the device in a two-dimensional or three-dimensional space and provide as an output a series of readings of the acceleration. Based on the acceleration and/or orientation readings, the device may determine whether the device is or was in motion. The device can use the motion to control various functions or application programs of the device. For example, the device may use the series of readings as an input to an application program. Based on the motion sensor readings, the application program can perform various actions. More specifically, the motion data may be used to perform an action related the timer associated with the display 110 (e.g., reset the display timer).

The motion sensor 105 may include any suitable motion sensor operative to detect movements of the device. For example, the motion sensor 105 may be operative to detect a motion event of a user carrying the device. In some implementations, the motion sensor 105 may include one or more three-axis acceleration motion sensors (e.g., an accelerometer) operative to detect linear acceleration in three directions (i.e., the x or left/right direction, the y or up/down direction, and the z or forward/backward direction). As another example, the motion sensor 105 may include one or more single-axis or two-axis acceleration motion sensors which may be operative to detect linear acceleration only along each of the x or left/right direction and the y or up/down direction, or along any other pair of directions. In some implementations, the motion sensor 105 may include an electrostatic capacitance (e.g., capacitance-coupling) accelerometer that is based on silicon micro-machined micro electro-mechanical systems (“MEMS”) technology, including a heat-based MEMS type accelerometer, a piezoelectric type accelerometer, a piezoresistance type accelerometer, or any other suitable accelerometer.

In some implementations, the motion sensor 105 may be operative to directly detect rotation, rotational movement, direction of magnetic fields, angular displacement, tilt, position, orientation, motion along a non-linear (e.g., arcuate) path, or any other non-linear motions. For example, if the motion sensor 105 is a linear motion sensor, additional processing may be used to indirectly detect some or all of the non-linear motions. For example, by comparing the linear output of the motion sensor 105 with a gravity vector (i.e., a static acceleration), the motion sensor 105 may be operative to calculate the tilt of the device with respect to the y-axis. In some implementations, the motion sensor 105 may alternatively or additionally include one or more gyro-motion sensors or gyroscopes for detecting rotational movement. For example, the motion sensor 105 may include a rotating or vibrating element.

In one implementation, the motion sensor 105 may be a standalone device. In such implementation, the processing unit 215 may comprise a communications interface 140. The communications interface 140 may be provided to allow the device to communicate with one or more other electronic devices or servers (not shown) using any suitable communications protocol. For example, the communications circuitry may support Wi-Fi (e.g., an 802.11 protocol), Ethernet, Bluetooth, and/or alike.

In one implementation, in response to the detection of motion, the motion data may be communicated to the processing unit 115. The sensor 105 may provide input to the processor 120. The sensor 105 may notify the processor 120 of motion events when a motion is determined. There may be various types of user motion events that may be detected by the motion sensor 105 for generating motion sensor data to be analyzed by the processing unit 115. For example, the motions may be any suitable type of user motion event associated with a user attempting to actively interact with the device such as the user shaking or tilting the motion sensor 105, or unconscious movements caused by imperceptible movements, such as shaking that is caused by the user holding the device in hand, propping it up on lap, etc. Further, the sensor data may be used to determine the type of activity being performed by the user (e.g., navigate a menu hierarchy of an application or to control the play of a video game being provided by the device).

In some implementations, the processing unit 115 may load a motion sensing application (e.g., an application stored in the computer readable medium 130). The motion sensing application may provide the device with various rules for utilizing the motion sensor data generated by the motion sensor 105. For example, the rules may determine how the device handles the motion event (e.g., whether or not the device changes a function or setting in response to detecting the motion). Additionally or alternatively, the rules may determine how the device analyzes the motion sensor data in order to distinguish the particular type of user motion event that caused the movement detected by the motion sensor 105 (e.g., a user input event, or an event not necessarily intended by the user (e.g., an unintentional motion)).

In one implementation, the processor 120 may be in data communication with the computer readable medium 130. The processor 120 may retrieve and execute instructions stored in the computer readable medium 130. The processor 120 may be, for example, a central processing unit (CPU), a semiconductor-based microprocessor, an application specific integrated circuit (ASIC), a field-programmable gate array (FPGA) configured to retrieve and execute instructions, other electronic circuitry suitable for the retrieval and execution instructions stored on a computer readable storage medium, or a combination thereof. The processor 120 may fetch, decode, and execute instructions stored on the storage medium 130 to operate the device in accordance with the above-described examples. The computer readable medium 130 may be a non-transitory computer-readable medium that stores machine readable instructions, codes, data, and/or other information. In certain implementations, the computer readable medium 130 may be integrated with the processor 220, while in other implementations, the computer readable medium 130 and the processor 120 may be discrete units.

In one implementation, the computer readable medium 130 may include program memory that includes programs and software such as an operating system, user detection software component, and any other application software programs. Further, the computer readable medium 130 may participate in providing instructions to the processor 120 for execution. The computer readable medium 130 may be one or more of a non-volatile memory, a volatile memory, and/or one or more storage devices. Examples of non-volatile memory include, but are not limited to, electronically erasable programmable read only memory (EEPROM) and read only memory (ROM). Examples of volatile memory include, but are not limited to, static random access memory (SRAM) and dynamic random access memory (DRAM). Examples of storage devices include, but are not limited to, hard disk drives, compact disc drives, digital versatile disc drives, optical devices, and flash memory devices.

In one implementation, the computer readable medium 130 may have a user profile database. The user profile database may store user profile data such as user identification data, user interface data, and profile management data and/or the like. In another implementation, the computer readable medium 130 may have a user activity database. The user activity database may store activity data such as location, reading, watching a video, and/or the like.

In one implementation, the processor 120 may comprise a module that processes the motion data captured by a motion sensor in the device. This module may also be used to respond to the detection of the motion by determining whether the motion meets the threshold preset by the system 100 or the user. Moreover, the processor 120 may also include a software module that controls a timer of the display based on the motion data obtained by the sensor. Alternatively or in addition, the processor 120 may provide a way for a user to interact with the system 100 to modify the timer or sensor settings.

The processor 120 may be powered by the power 150. More specifically, the power 150 may comprise any suitable circuitry for receiving and/or generating power, and for providing such power to one or more components of the device. For example, the power 150 may be able to provide power to the processor 120, to the computer readable medium 130, and to the motion sensor 105. The power 150 may be responsible for coordinating certain functions of the device, including, but not limited to, monitoring power connections and battery charges, controlling power provided to other components of the device, shutting down certain components of the device when they may be left idle or deemed to be currently unnecessary to properly operate the device, regulating a real-time clock of the device, and controlling various power management modes of the device.

In one implementation, the device may include different power modes for controlling and managing power consumption by the components of the device and any devices that may be coupled to the device. In another implementation, the power 150 may be used to manage power supplied to the device, and stop supplying the power to the device upon the condition that the device has not been used for a specified time (e.g., ten minutes). In some implementations, the specific time may be predetermined by the user. In other implementations, the specific time may be a default setting by the system of the device. In one implementation, the display timer 160 may track the time that the device has not been used for, and communicates this measurement to the controller 170.

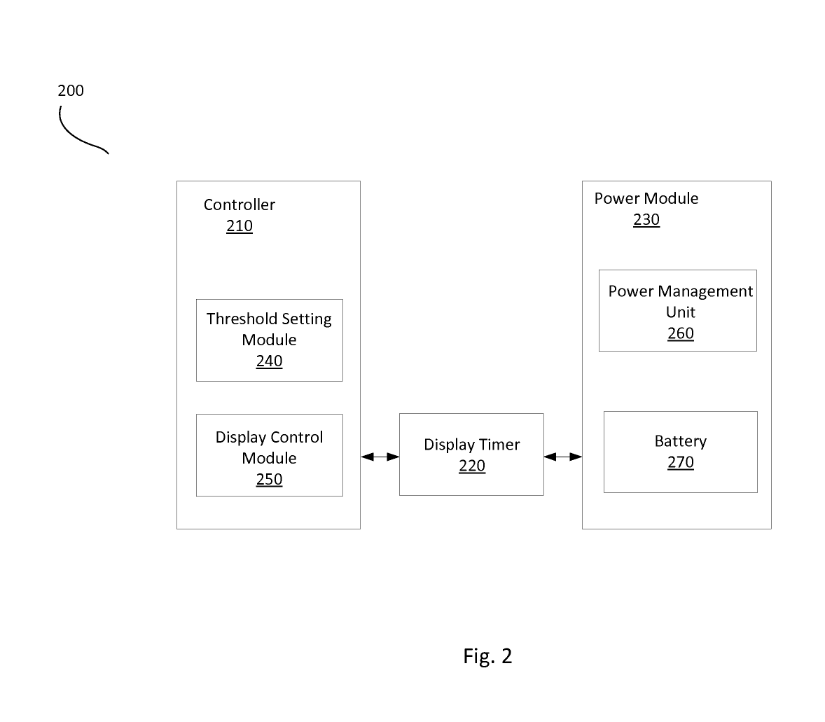

The controller 170 may include a plurality of functional modules that may be executed by the processor 120. These modules will be explained in greater detail in reference to FIG. 2. For example, the controller 170 may be a component in the form a chip (e.g., ASIC). Such controller may be designed to automatically control a screen function. More specifically, the controller 170 may instruct the display 110 to transition from one display mode (e.g., normal display mode) to another mode (e.g., power saving mode) based on the time reading received from the display timer 160. In one implementation, the controller 170 may compare the time from the display timer 160 with the specified time (e.g., thirty seconds). If the tracked time is greater than or equal to the specified time, the controller 170 may send a control command to the display 110 to switch display modes. Alternatively or in addition, the controller 170 may send a command to the power 150 of the device to stop supplying power to the device. In another implementation, the controller 170 may issue a command to the display timer 160 to reset the time measurement in response to the detection of device activity (e.g., the device is moved).

More specifically, the controller 170 may receive data from the sensor 205, process the data, and pass the processed data to the processor 120. Such processed data may comprise functions responsive to the motion of the device detected by the sensor 105. In another implementation, the controller 170 may receive motion data related to input devices such as touch-sensitive screen digitizers, and pointing devices such as computer mice, trackballs, or touch pads. The controller 170 may process the data from such devices, and output the processed data in a form that may represent commands for future actions. In one implementation, the controller 170 and the processor 120 may exist as one unit. In another implementation, as illustrated in FIG. 1, the controller 170 and the processor 120 may exist separately.

In one implementation, the controller 170 may have a threshold considered for motion data analysis. The threshold value for the motion may be on the order of 0.15 m/sec² or less or more, and may vary significantly with the type of sensing technology used and the accuracy desired. More specifically, the controller 170 may choose to consider motions that are higher than the threshold, and may choose to ignore the motions that are less than the threshold. In some implementations, the threshold value may be identified by the user. In other implementation, the threshold value may be a default setting in the application associated with the motion sensor. In one example, the threshold value may be adjusted by the user.

In one implementation, no threshold value may be defined. In such implementation, the controller 170 may consider any motion detected by the sensor 205.

The display 110 may be a display of content for the device. In one implementation, the display 110 may be a display of the device. The display 110 may refer to the graphical, textual and auditory information a program may present to the user, and the control sequences (e.g., keystrokes with the keyboard) the user may employ to control the program. In some implementations, the display 110 may include image display circuitry (e.g., a screen or projection system) as an output component for providing a display visible to the user.

In one example, the display 110 may present various pages that represent applications available to the user. A user interface on the display 110 may facilitate interactions between the user and the device by inviting and responding to user input and translating actions (e.g., tasks) and results to a language or image that the user can understand. In another implementation, the device may receive input from a plurality of input devices, such as a keyboard, mouse, touch device, or verbal command.

In one implementation, consistent with the present disclosure, the display 110 may be a part of the device. In another implementation, the display 110 may be a stand-alone unit, separate from the device. In such implementation, the display 110 may be connected to the device through any type of interface or connection, including I2C, SPI, PS/2, Universal Serial Bus (USB), Bluetooth, RF, IRDA, keyboard scan lines or any other type of wired or wireless connection to list several non-limiting examples.

In one implementation, the display 110 may have different modes depending on the power mode of the power 150. For example, a normal display mode of the display 110 may be defined as a display mode of the display 110 for normally displaying information of the device when the display 110 is being used. Moreover, a power saving mode may be defined as a display mode of the display 110 that works in a low power state when the display 110 is not in use. The power saving mode may be converted into the normal mode for normally displaying information of the device when the display 110 is being used. In one implementation, the controller 170 may instruct the display 110 to switch from the normal display mode to a dimmed display mode in response to the time measurement the controller 170 receives from the display timer 160.

FIG. 2 illustrates example components of the system 200 in accordance with an implementation. The system 200 provides a more detailed illustration of the components of the system 100 of FIG. 2. More specifically, the system 200 comprises a controller 210, a display timer 220 and a power module 230, each of which is described in greater detail below. The controller 210 comprises a threshold setting module 240 and a display control module 250. Further, the power module 230 comprises a power management unit 260 and a battery 270. It should be readily apparent that the system 200 illustrated in FIG. 2 represents a generalized depiction and that other components may be added or existing components may be removed, modified, or rearranged without departing from a scope of the present disclosure.

In one implementation, the power module 230 of the device may include a battery 270. The battery 270 may be a gel, nickel metal hydride, nickel cadmium, nickel hydrogen, lead acid, lithium-ion, lithium polymer, or other type of battery. The power module 230 may also comprise power management unit 260 coupled to at least one source of power, such as the battery 270. As discussed above in more detail in reference to FIG. 1, the power management unit 260 may be responsible for coordinating certain functions of the device, including, but not limited to, monitoring power connections and battery charges, controlling power provided to other components of the device, shutting down certain components of the device when they may be left idle or deemed to be currently unnecessary to properly operate the device, regulating a real-time clock of the device, and controlling various power management modes of the device. In another implementation, the power management unit 260 may provide power and communicate other information to various components of the device. The power module 230 may comprise any suitable circuitry for receiving and/or generating power, and for providing such power to one or more components of the device. For example, as shown in FIG. 1, the power management unit 260 may be able to provide power to the processor 120, to the computer readable medium 130, and to the motion sensor 105.

In some implementations, the power management unit 260 may include a microcontroller and can be configured to govern the power functions of the device. The power management unit 260 may include its own memory (e.g., loaded with software and/or firmware), processor with input/output functionality and timers, as well as one or more converters for measuring the power provided by the battery 270.

In one implementation, the power management unit 260 may be used to manage power supplied to the device, and stop supplying the power to the device upon the condition that the device has not been used for a specified time (e.g., ten minutes). As explained above in more detail in reference to FIG. 1, the display timer 220 tracks the time during which the device has not been used. In one implementation, the display timer 220 may comprise a time recording module (not shown). The time recording module may send a time record command to the display timer 220, and obtain a recorded time using the display timer 220. The device may switch from the high active power management mode to another type of power management mode based on the time tracked by the display timer 220. For example, it may be determined that the components of the device have not been utilized for longer than the specified period of time (e.g., the time tracked by the display timer 220 is greater than the specified period of time). Therefore, the power module 230 may stop providing power to the components of the device until it is determined that the component may once again be required by the processor (e.g., the processor 120 as illustrated in FIG. 1).

In some implementations, under certain conditions, the display timer 220 may reset the time being tracked. For example, the device may move and accordingly, the motion sensor in the device may detect the motion event. In response to the motion event, the controller 210 may issue a command to the display timer 220 to reset the time. If no device activity such as a motion event has occurred, the display timer 220 may keep running.

In some implementations, only certain motion events may trigger the reset action. More specifically, the controller 210 may apply a preset threshold to determine if the motion event detected is qualified to trigger the reset action. The threshold setting module 240 in the controller 210 determines whether the motion event measurement is higher than the threshold value. As explained above in more detail in reference to FIG. 1, the threshold value for a motion event may be predetermined by a user, or may be a default setting of the system. In one example, the threshold value may vary based on the type of the motion event (e.g., reading, watching a movie). In another example, the threshold value may vary based on the user profile (e.g., an adult user, a child user). In a further example, the threshold value may vary based on the position of the device (e.g., docked or undocked in a docking station). In another example, the threshold value may vary depending on the device's power setup (e.g., plugged in or battery). In another example, the threshold value may vary based on the location of the device. For example, a user of the device may place the device in a car while driving, and the movement of the car may be detected by the sensor. The threshold value may vary based on the orientation and/or location of the device in the car (e.g., placed horizontally on the seat of the car or placing vertically on the top of the dashboard). In some examples, the threshold value may vary based on the surrounding of the device. For example, in one implementation, the threshold value may be set to a very high number for situations where the sensor detects that the device is placed into a storage location (e.g., a pocket, a bag, a closed case). In another implementation, when the sensor detects that the device is placed in a storage location, the system may terminate the interaction with the display timer 220.

In the event that the motion event measurement is over the threshold value, the display control module 250 in the controller 210 may issue a command to the display timer 220 to reset the time.

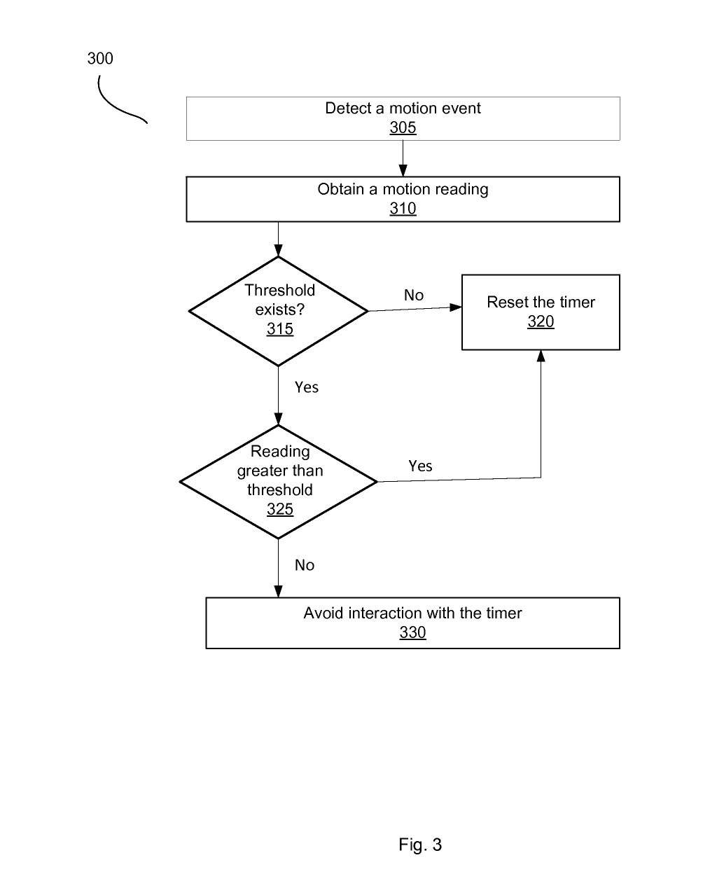

Turning now to the operation of the system 100, FIG. 3 illustrates an example process flow diagram 300 in accordance with an implementation. It should be readily apparent that the processes illustrated in FIG. 3 represents generalized illustrations, and that other processes may be added or existing processes may be removed, modified, or rearranged without departing from the scope and spirit of the present disclosure. Further, it should be understood that the processes may represent executable instructions stored on memory that may cause a processor to respond, to perform actions, to change states, and/or to make decisions. Thus, the described processes may be implemented as executable instructions and/or operations provided by a memory associated with a system 100. Alternatively or in addition, the processes may represent functions and/or actions performed by functionally equivalent circuits like an analog circuit, a digital signal processor circuit, an application specific integrated circuit (ASIC), or other logic devices associated with the system 100. Furthermore, FIG. 3 is not intended to limit the implementation of the described implementations, but rather the figure illustrates functional information one skilled in the art could use to design/fabricate circuits, generate software, or use a combination of hardware and software to perform the illustrated processes.

The process 300 may begin at block 305, where the motion sensor detects a motion event. In particular, this process may involve detecting that the device has been moved. In one implementation, the device may be operating in a high active power mode when power is being provided to some or all of the components of the device. For example, with respect to FIG. 1, the device may be operating in a high active power mode when the power 150 is providing power to the processor 120, the computer readable medium 130, and the motion sensor 105.

At block 310, the system proceeds to obtain a reading of the motion event. The reading may be an acceleration measurement taken in m/sec² (e.g., 0.15 m/sec²). At block 315, the system determines whether the system has a specified threshold value of motion measurements. The threshold value identifies the specified magnitude of acceleration which may be any suitable measurement of acceleration for which the motion of the device may trigger a responsive action. The threshold value may be less than, equal to, or greater than the measurement of the motion event detected by the sensor. The threshold value may be defined by the motion sensing application, by other programs or components of the device, by the user of the device, or by any other suitable mechanism. The threshold value may be set to avoid processing minor incidental movements of the motion sensor but such that other types of movement of the motion sensor may be detected.

In the event that no threshold value is identified, at block 320, the system proceeds to reset the time based on the motion event detected. In the event that a threshold value exists, at block 325, it may be determined whether or not the motion event detected by the sensor is of a magnitude that exceeds the motion magnitude threshold.

If it is determined that the motion sensor has recently detected a motion event of a magnitude that exceeds the threshold, the system proceeds to block 320. At block 320, the system resets the timer in response to the detected motion event. If it is determined that the motion sensor has not detected a motion event of a magnitude that exceeds the threshold, at block 330, process 300 comes to an end, where the timer keeps running and tracking the time during which the device has not been used.

The present disclosure has been shown and described with reference to the foregoing exemplary implementations. It is to be understood, however, that other forms, details, and examples may be made without departing from the spirit and scope of the disclosure that is defined in the following claims. As such, all examples are deemed to be non-limiting throughout this disclosure.

What is claimed is:

1. A method for controlling a display timer of a device, comprising:
obtaining, by a processor, a motion reading of a motion event associated with the device from a motion sensor;
comparing, by a controller, the motion reading to a threshold value; and
performing, by the controller, an action on the display timer associated with a display unit of the device based on the comparison, the action maintaining the display unit in a normal display mode.

2. The method of claim 1, further comprising detecting, by the motion sensor, motion of the device.

3. The method of claim 1, wherein comparing the motion reading to the threshold value further comprises determining whether the motion reading of the motion event exceeds the threshold value.

4. The method of claim 1, wherein performing the action on the display timer of the device based on the comparison further comprises resetting the display timer if the motion reading of the motion event exceeds the threshold value.

5. The method of claim 1, wherein performing the action on the display timer of the device based on the comparison further comprises avoiding interaction with the display timer if the motion reading of the motion event does not reach the threshold value.

6. The method of claim 1, wherein the display timer determines when the normal display mode of the display unit is to be terminated.

7. The method of claim 1, wherein the motion event comprises at least one activity.

8. The method of claim 7, wherein the at least one activity comprises at least one movement performed by a user of the device while holding the device.

9. The method of claim 7, wherein the threshold value varies based on the at least one activity.

10. The method of claim 1, wherein the threshold value varies based on a profile of a user of the device.

11. The method of claim 1, wherein the threshold value is predetermined by a manufacturer of the device.

12. The method of claim 1, further comprising deactivating the display timer when the device is connected to a docking station.

13. The method of claim 1, wherein the device stays in the normal display mode regardless of the comparison of the motion reading to the threshold value.

14. The method of claim 1, terminating the performance of the action if the location of the device is identified to be in a storage location.

15. An system, comprising:
a motion sensor unit to detect a motion of the system; and
a processing unit communicatively coupled to the motion sensor unit to:
obtain a motion reading of a motion event associated with the device from a motion sensor,
compare the motion reading to a threshold value, and
perform an action on a display timer on the device based on the comparison, the action maintaining the device in a normal display mode.

16. The system of claim 15, wherein the processing unit comprises a controller to determine the action to be performed on the display timer.

17. The system of claim 15, further comprising a display unit coupled to the processing unit, to present data to a user, the display unit having a plurality of display modes.

18. The system of claim 15, wherein the processing unit comprises a controller to determine a display mode for the display unit.

19. A non-transitory computer-readable medium comprising instructions that when executed cause a system to:
obtain a motion reading of a motion event associated with a device from a motion sensor;
compare the motion reading to a threshold value; and
perform an action on a display timer associated with a display unit of the device based on the comparison, the action maintaining the display unit in a normal display mode.

20. The non-transitory computer-readable medium of claim 19, wherein the action comprises resetting the display timer if the motion reading of the motion event exceeds the threshold value.
